(19) United States
(12) Patent Application Publication
(10) Pub. No.: US 2021/0051233 A1
(43) Pub. Date: Feb. 18, 2021

(54) MUTED COMPONENT DETECTION

(71) Applicant: Lenovo (Singapore) Pte. Ltd., Singapore (SG)

(72) Inventors: Robert James Kapinos, Durham, NC (US); Robert James Norton, JR., Raleigh, NC (US); Scott Wentao Li, Cary, NC (US); Russell Speight VanBlon, Raleigh, NC (US)

(21) Appl. No.: 16/542,936

(22) Filed: Aug. 16, 2019

(51) Int. Cl. H04M 3/56; H04M 7/00; G10K 11/16; H04M 9/08; G10L 25/84; H04R 3/00

(52) U.S. Cl. CPC H04M 3/569; H04M 7/006; H04R 3/007; H04M 9/082; G10L 25/84; G10K 11/16

(57) ABSTRACT

One embodiment provides a method, comprising: transmitting, from a communication component, a signal down a communication channel; determining, using a processor, whether an echo associated with the signal is detected by the communication component; and providing, responsive to determining that the echo is not detected, a notification to a user that a mute control is enabled at another communication component along the communication channel. Other aspects are described and claimed.

### BACKGROUND

Individuals frequently utilize their information handling devices (“devices”), for example, smart phones, tablet devices, laptop and/or personal computers, and the like, to engage in audible conversations with other individuals. Various communication applications and conferencing systems may be utilized to allow participants to dial into a virtual meeting from their own device. During the call, users may enable a mute control that disables an audio capture function of their audio capture device (e.g., a microphone, etc.) or prevents input captured by their audio capture device from being transmitted to other individuals on the call.

### BRIEF SUMMARY

In summary, one aspect provides a method, including: transmitting, from a communication component, a signal down a communication channel; determining, using a processor, whether an echo associated with the signal is detected by the communication component; and providing, responsive to determining that the echo is not detected, a notification to a user that a mute control is enabled at another communication component along the communication channel.

Another aspect provides an information handling device, comprising: a processor; a memory device that stores instructions executable by the processor to: transmit, from a communication component, a signal down a communication channel; determine whether an echo associated with the signal is detected by the communication component; and provide, responsive to determining that the echo is not detected, a notification to a user that a mute control is enabled at another communication component along the communication channel.

A further aspect provides a product, comprising: a storage device that stores code, the code being executable by a processor and comprising: code that transmits a signal down a communication channel; code that determines whether an echo associated with the signal is detected by the communication component; and code that provides, responsive to determining that the echo is not detected, a notification to a user that a mute control is enabled at another communication component along the communication channel.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of detecting a muted component in a communication channel.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Voice over Internet Protocol (VoIP) technology is commonly used to allow geographically diverse users to audibly communicate with each other over computer networks. While largely convenient and beneficial, VoIP sessions may suffer from the presence of a plurality of mute controls. More particularly, there may be a variety of different points of function along the communication channel where a mute control may be active. For example, there may be a mute control active on one or more hardware or software components (e.g., a user's headset, in the user's operating system (OS), in the VoIP program, in the system global mute, etc.) that the other components are not privy to. In these situations, a user may be unaware that their audible input never reaches the intended recipient(s).

In order to ensure that a user's transmitted audio signal reaches others in a VoIP, or other like conference, the mute controls at all of the points, or components, along the communication channel need to be inactive. Although some programs know to align their mute functions with a global mute control, this ability is not universal across all components, applications, and programs. As such, no conventional solutions exist for notifying a user that a mute control is active at some intermediate point along the communication channel.

Accordingly, an embodiment provides a method for apprising a user that a mute control is active at an intermediate point along a communication channel. In an embodiment, a signal may be transmitted down a communication channel. The signal may be shaped to have a specific waveform and may be transmitted from virtually any component along the communication channel (e.g., a user's headset, a VoIP client, a VoIP server, etc.). An embodiment may then determine whether the signal may be detected on the return journey back up the communication channel. If an echo of the signal is not detected, an embodiment may conclude that a mute control is active at some point along the communication channel and provide a notification informing the user of the same. Additionally or alternatively, the notification may identify the precise communication component that has an active mute control enabled and thereafter disable the mute control. Such a method may inform a user of an active intermediate mute so that they do not unintentionally provide input that is never heard by one or more intended individuals.

The illustrated example embodiments will be best understood by reference to the figures. The following description is intended only by way of example, and simply illustrates certain example embodiments.

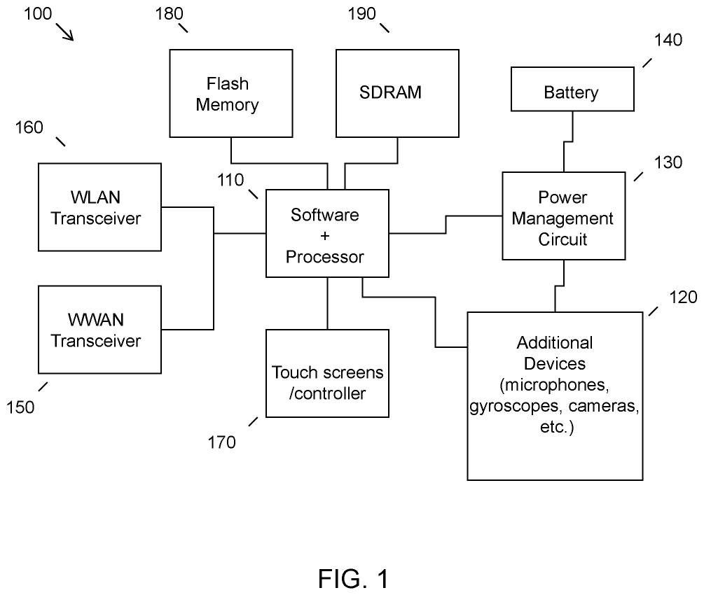

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, motion sensor such as an accelerometer or gyroscope, etc. System 100 often includes one or more touch screens 170 for data input and display/rendering. System 100 also typically includes various memory devices, for example flash memory 180 and SDRAM 190.

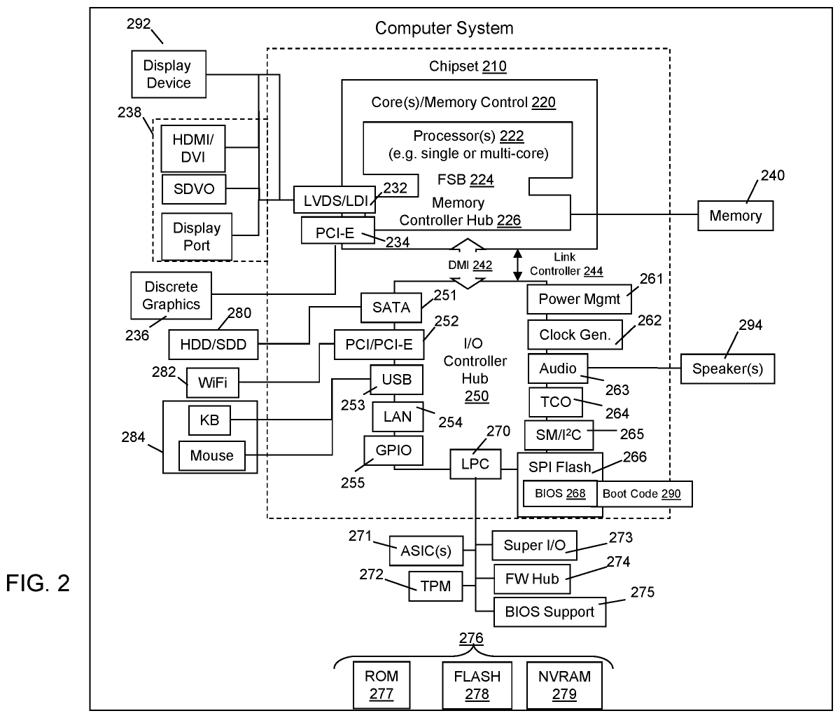

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices capable of supporting one or more types of conferencing/communication applications (e.g., VoIP-based applications, etc.). For example, the circuitry outlined in FIG. 1 may be implemented in a smart phone embodiment, whereas the circuitry outlined in FIG. 2 may be implemented in a laptop.

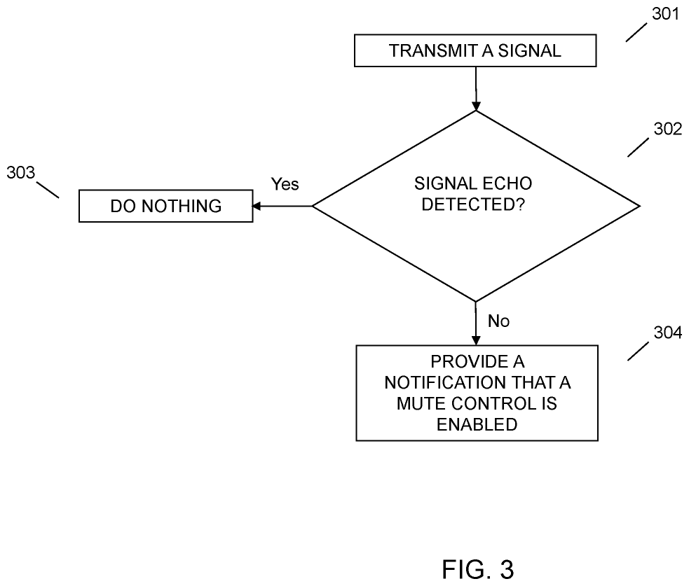

Referring now to FIG. 3, an embodiment may detect one or more components that may be muted in a communication channel and apprise the user of this information. At 301, an embodiment may transmit a signal, or chirp, down a communication channel. In the context of this application, a communication channel may refer to a transmission pathway (e.g., between two or more VoIP clients, between two or more VoIP-associated components, etc.) along which packet-switched signals may travel. In an embodiment, the signal may be transmitted from virtually any component components (e.g., a user's headset, a VoIP client, a VoIP server, other communication components, and the like) that may be present along the channel.

In an embodiment, the signal may be shaped to comprise a unique waveform. The shaped nature of the signal may serve a multitude of purposes. For example, knowledge of the unique waveform may allow receiving VoIP components to identify the signal as a chirp and know to reflect the signal back up the communication channel (i.e., to the transmitting VoIP component). Additionally or alternatively, the shaped-nature of the signal may allow the signal to circumvent various acoustic-echo cancellation routines. For example, if various noise cancellation hardware or software (e.g., a noise reduction layer, a noise reflecting microphone, etc.) are present in the communication channel, shaping the signal may prevent the these noise cancelling components to filter, or block the signal, as it makes its journey through the channel. In an embodiment, the signal may be a single shape (e.g., a singularly defined waveform, etc.) or may be comprised of a set of common shapes.

In an embodiment, the transmission of the signal may be initiated periodically (e.g., every hour, every 12 hours, every 24 hours, etc.) or may be initiated in response to a predetermined event (e.g., when the user's device is turned on, upon identification that the user has joined a VoIP server, in response to an explicit user command, etc.). The frequency with which the signals are transmitted may be originally set by a manufacturer and later adjusted by a user.

At 302, an embodiment may determine whether an echo of the signal is detected by the communication component. More particularly, in the context of this application, the detection of a signal echo may correspond to the detection, by the transmitting component, of the signal after it was originally transmitted. A positive detection may provide an indication that the transmitted signal successfully made a roundtrip journey through the communication channel. Conversely, if the signal echo is not detected, an embodiment may conclude that a mute control may be active on some component in the channel.

Responsive to determining, at 302, that a signal echo was detected, an embodiment may at 303, take no additional action. Stated differently, the detection of the signal may provide an inherent indication that all mute controls on components involved in the communication channel are inactive. Additionally or alternatively, an embodiment may provide a notification to the user (e.g., a visual notification such as a displayed message or green light, an audible notification, etc.) that the communication channel is clear of all mutes. Conversely, responsive to determining, at 302, that a signal echo was not detected, an embodiment may, at 304, provide a notification to the user of the same. More particularly, an embodiment may notify (e.g., using an audio or visual notification, etc.) a user that a mute control is active on some component in the channel and that provided audible input will not reach the intended recipient(s). For example, speakers in a user's headset may inform the user they may be muted. As another example, a VoIP client may display a message on a screen of a user's device informing them that they are muted.

In an embodiment, the notification may comprise an indication of the component(s) in the communication channel on which the mute controls are enabled. This indication may provide some additional context to the user regarding where in the channel an issue may reside. Such an embodiment may be possible in situations where each of the VoIP components are compatible with one another (e.g., when the VoIP components are all in the same software and/or hardware ecosystem and able to effectively communicate with one another).

In an embodiment, once the user knows that a mute is enabled, or which precise component is muted, they may take action to deactivate the mute. Additionally or alternatively, an embodiment may be able to dynamically deactivate the mute controls on the muted component once a negative determination is made at 302. More particularly, an embodiment may deactivate the mute control on the muted component using another component or, alternatively, an embodiment may request the muted component to deactivate its own mute controls. Additionally or alternatively, in another embodiment, the originally muted component(s) may be requested to tie into a global system mute control (i.e., a system control that may simultaneously control the mute status of each component in the communication channel).

The various embodiments described herein thus represent a technical improvement to conventional methods of detecting an intermediate mute in a communication channel. Using the techniques described herein, an embodiment may transmit a chirped signal down a communication channel. An embodiment may then monitor for the signal on its return journey back up the communication channel. If the signal is detected (e.g., by the transmitting component, etc.), an embodiment may assume that the channel is free of muted components. However, if the signal is not detected, an embodiment may conclude that a mute control is active on one or more hardware or software component in the channel and may provide a notification to the user informing them of this result. Such a method may therefore apprise a user whether their audible inputs will be registered by intended recipients in a networked conference.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
transmitting, from a communication component, a signal down a communication channel, wherein the signal is shaped to comprise a predetermined waveform;
determining, using a processor, whether the signal is detected again by the communication component; and
providing, responsive to determining that the signal is not detected, a notification to a user that a mute control is enabled at another communication component along the communication channel, wherein the notification comprises an identification of the another communication component at which the mute control is enabled.

2. The method of claim 1, wherein the communication component is a component selected from the group consisting of a headset microphone, a VoIP client, and a VoIP server.

3. (canceled)

4. The method of claim 1, wherein the predetermined waveform is able to circumvent at least one noise cancellation mechanism present in the communication channel.

5. The method of claim 1, wherein the notification comprises identification of the another communication component at which the mute control is enabled.

6. The method of claim 5, further comprising dynamically deactivating the mute control on the identified another communication component.

7. The method of claim 6, further comprising aligning the mute control with a global operating system.

8. The method of claim 1, wherein the providing the notification comprises providing an audible notification through a headset.

9. The method of claim 1, wherein the providing the notification comprises providing a visual notification on a display screen of an information handling device.

10. (canceled)

11. An information handling device, comprising:
a processor;
a memory device that stores instructions executable by the processor to:
transmit, from a communication component, a signal down a communication channel, wherein the signal is shaped to comprise a predetermined waveform;
determine whether the signal is detected again by the communication component; and
provide, responsive to determining that the signal is not detected, a notification to a user that a mute control is enabled at another communication component along the communication channel, wherein the notification comprises an identification of the another communication component at which the mute control is enabled.

12. The information handling device of claim 11, wherein the communication component is a component selected from the group consisting of a headset microphone, a VoIP client, and a VoIP server.

13. (canceled)

14. The information handling device of claim 13, wherein the predetermined waveform is able to circumvent at least one noise cancellation mechanism present in the communication channel.

15. The information handling device of claim 11, wherein the notification comprises an identification of the another communication component at which the mute control is enabled.

16. The information handling device of claim 15, wherein the instructions are further executable by the processor to deactivate the mute control at the another communication component.

17. The information handling device of claim 16, wherein the instructions are further executable by the processor to align the mute control with a global mute control.

18. The information handling device of claim 11, wherein the instructions executable by the processor to provide the notification comprise instructions executable by the processor to provide an audible notification through a headset.

19. The information handling device of claim 11, wherein the instructions executable by the processor to provide the notification comprise instructions executable by the processor to provide a visual notification on a display screen associated with the information handling device.

20. A product, comprising:
a storage device that stores code, the code being executable by a processor and comprising:
code that transmits a signal down a communication channel, wherein the signal is shaped to comprise a predetermined waveform;
code that determines whether the signal is detected by the communication component; and
code that provides, responsive to determining that the signal is not detected, a notification to a user that a mute control is enabled at another communication component along the communication channel, wherein the notification comprises an identification of the another communication component at which the mute control is enabled.
